(19) United States
(12) Patent Application Publication
(10) Pub. No.: US 2026/0096581 A1
(43) Pub. Date: Apr. 9, 2026

(54) FISH BONE POWDER, AND METHOD AND DEVICE FOR PREPARING THE SAME

(71) Applicant: National Pingtung University of Science and Technology, Pingtung County (TW)

(72) Inventor: Earl-Juei WANG, Pingtung County (TW)

(21) Appl. No.: 19/169,114

(22) Filed: Apr. 3, 2025

(30) Foreign Application Priority Data
Oct. 9, 2024 (TW) 113138497

(51) Int. Cl. A23L 17/10; A23L 5/10; A23L 33/15; A23L 33/155; A23L 33/16

(52) U.S. Cl. CPC A23L 17/10; A23L 5/13; A23L 33/15; A23L 33/155; A23L 33/16

(57) ABSTRACT

A method for preparing a fish bone powder includes: providing a medium powder made from fish bones and containing calcium and phosphorus, and a base powder containing vitamin B3; mixing the medium powder and the base powder to obtain a powder mixture; subjecting the powder mixture to a first heating process conducted at 40° C. to 60° C. and then to a second heating process conducted at 60° C. to 80° C., so as to obtain a processed powder; and adding a vinegar solution to the processed powder so that the processed powder undergoes a fermentation reaction. A device for preparing the fish bone powder, and the fish bone powder are also provided.

### CROSS-REFERENCE TO RELATED APPLICATION

This application claims priority to Taiwanese Invention patent application No. 113138497, filed on Oct. 9, 2024, and incorporated by reference herein in its entirety.

### FIELD

The present disclosure relates to a fish bone powder, a method for preparing the fish powder, and a device for preparing the same.

### BACKGROUND

Maintenance of bone health mainly focuses on supplementation of calcium. Despite active consumption of calcium through food or dietary/health products, whether the human body is capable of replenishing sufficient amount of calcium to achieve desirable effects, e.g. bone strengthening, optimization of physical fitness, etc., largely depends on the amount of calcium absorbed by the human body. In recent years, research has shown that, in order to achieve the effect of bone strengthening, calcium in the blood will only be absorbed into the bones when an amount ratio of calcium to phosphorus in the blood is 2:1. In contrast, loss of calcium from the bone will occur if the amount ratio of calcium to phosphorus in the blood is not 2:1.

Therefore, apart from taking vitamin D supplements during food consumption for optimizing calcium absorption, those skilled in the art strive to develop a novel method for preparing a health product that, upon consumption, is capable of achieving the aforesaid amount ratio of calcium to phosphorus in the blood so as to ensure that calcium intake indeed achieves the effect of maintaining and/or promoting bone health.

### SUMMARY

Therefore, an object of the present disclosure is to provide a method for preparing a fish bone powder, and a device for preparing a fish bone powder, and a fish bone powder that can alleviate at least one of the drawbacks of the prior art.

According to an aspect of the present disclosure, the method includes the steps of:
(A) providing a medium powder that is made from fish bones and containing calcium and phosphorus, and a base powder containing vitamin D3;
(B) mixing the medium powder and the base powder to obtain a powder mixture;
(C) subjecting the powder mixture to a first heating process conducted at a first temperature ranging from 40° C. to 60° C. and then to a second heating process conducted at a second temperature ranging from 60° C. to 80° C., so as to obtain a processed powder; and
(D) adding a vinegar solution to the processed powder so that the processed powder undergoes a fermentation reaction.

According to another aspect of the present disclosure, the device includes a supply unit, a processing unit disposed downstream of the supply unit, and a supplementing unit connected to the processing unit. The supply unit includes a first feeding module used for storing and feeding a medium powder containing calcium and phosphorus, and a second feeding module that is independent from the first feeding module and that is used for storing and feeding a base powder containing vitamin B3. The processing unit includes a heating furnace that is connected to the first feeding module and the second feeding module, and a stirring mechanism disposed in the heating furnace. The supplementing unit includes a supplementary module that is connected to the heating furnace and that is used for feeding a vinegar solution.

According to yet another aspect of the present disclosure, the fish bone powder is prepared by the aforesaid method, and contains calcium, phosphorus, collagen, vitamin B3, and calcitriol.

### BRIEF DESCRIPTION OF THE DRAWINGS

Other features and advantages of the present disclosure will become apparent in the following detailed description of the embodiment(s) with reference to the accompanying drawings. It is noted that various features may not be drawn to scale.

FIG. 1 is a flow diagram illustrating an embodiment of a method for preparing a fish bone powder according to the present disclosure.

FIG. 2 is a schematic view illustrating an embodiment of a device for preparing a fish bone powder according to the present disclosure.

FIGS. 3A and 3B are graphs showing calcium level and phosphorus level, respectively, in the serum of the mice of a control group and an experimental group of Example 1, infra.

FIGS. 4A and 4B are graphs showing alkaline phosphatase level and total cholesterol level, respectively, in the serum of the mice of the control group and the experimental group of Example 1, infra, in which the symbol “*” represents p<0.05 compared with the control group.

FIGS. 5A and 5B are graphs respectively showing percentage of body weight gain and amount of food intake for the mice of pathological control groups 1 and 2, an experimental group, and comparative groups 1 to 3 of section A of Example 2, infra, in which the symbol “*” represents p<0.05 compared with the pathological control group 2.

FIGS. 6A and 6B are graphs respectively showing alkaline phosphatase level and total cholesterol level in the serum of the mice of the pathological control groups 1 and 2, experimental group, and comparative groups 1 to 3 of section A of Example 2, infra, in which the symbols “*” and “**” respectively represents and p<0.05 and p<0.01 compared with the experimental group.

FIGS. 7A, 7B and 7C are graphs respectively showing phosphorus level, calcium level and osteocalcin level in the serum of the mice of the pathological control groups 1 and 2, experimental group, and comparative groups 1 to 3 of section A of Example 2, infra, in which the symbols “**”, and “***” respectively represent p<0.05, p<0.01 and p<0.001 compared with the experimental group.

FIGS. 8A and 8B are graphs respectively showing alkaline phosphatase level and total cholesterol level in the serum of the mice of the pathological control group 2, experimental group, and comparative groups 1 to 3 of section B of Example 2, infra, in which the symbol “*” represents p<0.05 compared with the pathological control group 2.

FIGS. 9A to 9C are graphs respectively showing phosphorus level, calcium level and osteocalcin level in the serum of the mice of the pathological control group 2, experimental group, and comparative groups 1 to 3 of section B of Example 2, infra, in which the symbol “*” represents p<0.05 compared with the pathological control group 2.

FIG. 10 is a graph showing triglyceride level in the serum of the mice of the pathological control group 2, experimental group and comparative groups 1 to 3 of section B of Example 2, infra, in which the symbol “***” represents p<0.001 compared with the experimental group.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

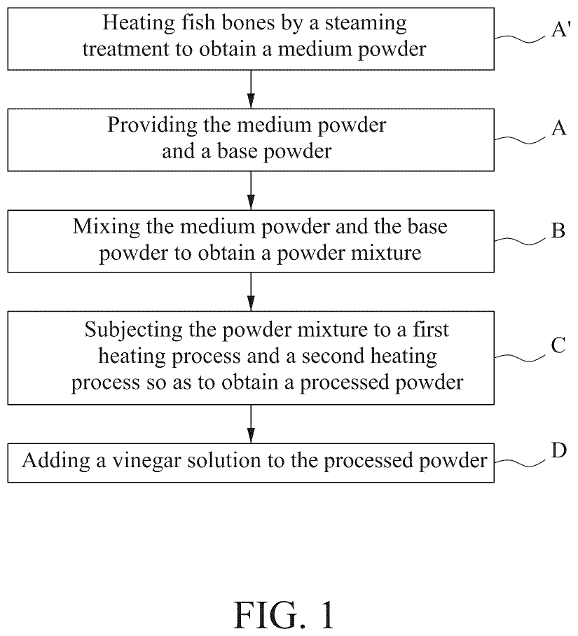

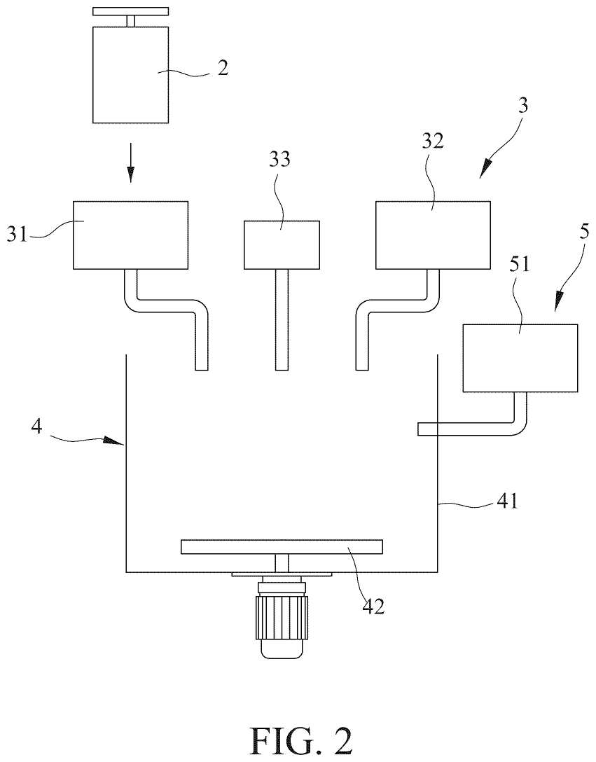

Referring to FIG. 1, an embodiment of a method for preparing a fish bone powder according to the present disclosure includes the following steps (a) to (d). The embodiment of the method is implemented using an embodiment of a device for preparing a fish bone powder according to the present disclosure as shown in FIG. 2. The embodiment of the device for preparing the fish bone powder includes a pressure pot 2, a supply unit 3 disposed downstream of the pressure pot 2, a processing unit 4 disposed downstream of the supply unit 3, and a supplementing unit 5 connected to the processing unit 4.

Referring again to FIGS. 1 and 2, the method further includes, before step (A), a step (A′) of heating fish bones by a steaming treatment at a temperature of ranging from 80° C. to 140° C. and a pressure greater than normal atmospheric pressure for a time period ranging from 50 minutes to 80 minutes, so as to obtain a medium powder that is water-soluble. In certain embodiments, the steaming treatment is conducted at a temperature of 130° C. and a pressure greater than normal atmospheric pressure for 60 minutes. In certain embodiments, step (A′) is conducted using the pressure pot 2 that is disposed upstream of the supply unit 3 and that is used for heating the fish bones by the steaming treatment. The fish bones are not only rich in calcium, but also contains calcium phosphate and collagen. The fish bones may be sourced from farmed fish or fish in the wild, and inspection of the amount of heavy metal residues therein is relatively complete, so as to ensure compliance with relevant test standards. By conducting step (A′), in addition to softening of the fish bones through appropriate application of temperature and pressure over a period of time, the fish bones can be crushed to obtain the medium powder without losing the nutrients contained in such fish bones. In addition, the steaming treatment conducted under high temperature also kills bacteria that may remain on the fish bones, thereby maintaining the requirement of food hygiene and safety.

In step (A), the medium powder that is made from fish bones and containing calcium and phosphorus, a base powder containing vitamin B3, and a fish scale powder containing gelatinous substance are provided. In certain embodiments, the medium powder is a fish bone meal including water that is present in an amount of less than 3 wt % based on 100 wt % of the medium powder. The supply unit 3 includes a first feeding module 31 used for storing and feeding the medium powder, a second feeding module 32 that is independent from the first feeding module 31 and that is used for storing and feeding the base powder, and a third feeding module 33 that is connected to the processing unit 4 and that is used for storing and feeding the fish scale powder. The processing unit 4 includes a heating furnace 41 that is connected to the first feeding module 31, the second feeding module 32 and the third feeding module 33, and a stirring mechanism 42 disposed in the heating furnace 41.

In step (B), after the medium powder, the base powder and the fish scale powder are fed into the heating furnace 41 by the first feeding module 31, the second feeding module 32 and the third feeding module 33, respectively, the stirring mechanism 42 is operated to mix the medium powder, the base powder and the fish scale powder so as to obtain a powder mixture.

Thereafter, in step (C), the powder mixture is subjected to a first heating process conducted at a first temperature ranging from 40° C. to 60° C. and then to a second heating process conducted at a second temperature ranging from 60° C. to 80° C. using the heating furnace 41 that is configured to operate in a plurality of heating modes with different ranges of temperatures, so as to obtain a processed powder. By conducting the first heating process and the second heating process (i.e., heating in stages), calcium, phosphorus, vitamin D3, and other nutrients contained in the processed powder can be prevented from damage due to rapid or excessive thermal heating, and vitamin D3 is allowed to be converted into calcitriol through a reaction that only occurs in the human body, so as to achieve the effect of activating these substances.

In step (D), a vinegar solution was added to the processed powder so that the processed powder undergoes a fermentation reaction to allow the activated vitamin D3 and other nutrients in the processed powder to be further broken down so as to form small molecules that can be easily absorbed by the human body. The fermentation reaction was conducted for a time period ranging from 1 hour to 2 hours. The vinegar solution includes at least one type of vinegar. Example of the vinegar may include, but not limited to, an edible vinegar. An amount of the vinegar solution added to the processed powder is 1 wt % based on a total weight of the processed powder. In certain embodiments, step (D) may be conducted together with step (C). Step (D) is conducted using the supplementing unit 5 which includes a supplementary module 51 connected to the heating furnace 41. In this step, the supplementary module 51 is used for feeding the vinegar solution into the heating furnace 41 so that the vinegar solution is mixed with the processed powder. Afterwards, the resultant fish bone powder may be formulated as a fish bone food product in the form of tablets or capsules through granulation process or other processes well known to those skilled in the art.

The present disclosure also provides a fish bone powder which is prepared by the aforesaid method, and which contains calcium, phosphorus, collagen, vitamin D3, and calcitriol.

The present disclosure will be further described by way of the following examples. However, it should be understood that the following examples are intended solely for the purpose of illustration and should not be construed as limiting the present disclosure in practice.

### EXAMPLES

### General Experimental Materials

### 1. Experimental Mice

Female BALB/c mice (8 weeks old, with a body weight of greater than 20 g) used in the following experiments were purchased from BioLASCO Taiwan Co., Ltd. All the experimental mice were housed in an animal room with an independent air conditioning system under the following laboratory conditions: an alternating 12-hour light and 12-hour dark cycle, a temperature maintained at 24° C.±2° C., and a relative humidity maintained at 60% to 70%. The mice were provided with water and fed ad libitum. All experimental procedures involving the experimental mice were in compliance with the legal provision of the Animal Protection Act of Taiwan, and were carried out according to the guidelines of the Animal Care Committee of the Council of Agriculture, Taiwan.

### General Procedures

### 1. Statistical Analysis

All the experiments described below were performed in triplicates. The experimental data of all the test groups are expressed as mean±standard deviation (SD), and were analyzed using analysis of variance (ANOVA) test using GraphPad Prism software, so as to assess the differences between the groups. Statistical significance is indicated by p<0.05.

### Example 1. Evaluation of the Effect of Fish Bone Powder of the Present Disclosure on the Absorption of Calcium, Phosphorus and Other Biochemical Markers in Normal Mice

In order to evaluate the efficacy of the fish bone powder of the present disclosure on the absorption of calcium, phosphorus and other biochemical markers, e.g., alkaline phosphatase and total cholesterol, in normal mice, the following experiments were conducted.

The female mice as described in section 1 of the “General Experimental Materials” were randomly divided into a control group and an experimental group (n=8 mice in each group). Before start of feeding, blood was collected one time from the vein in the cheek pouch of each mouse as a baseline. Next, the mice in the control group were fed, via oral gavage with normal chow diet purchased from Altromin Spezialfutter GmbH & Co. KG, and the mice in the experimental group were fed, via oral gavage, with the fish bone food product containing the fish bone powder of the present disclosure. Each mouse was fed 1 time daily for a total period of 112 days (i.e., 16 weeks).

After completing the 112th day of administration of the normal diet or the fish bone food product containing the fish bone powder of the present disclosure, blood samples were collected from the veins of the cheek pouches of the mice in each group via puncture, and then was left to stand at room temperature for 2 hours so as to undergo coagulation. Thereafter, a centrifugation treatment was conducted at a speed of 3000 rpm and 4° C. for 10 minutes, so as to collect the resultant supernatant. Subsequently, each of the collected supernatants was diluted with double distilled water, so as to obtain a serum sample. Thereafter, the serum sample was subjected to determination of concentrations of calcium, phosphorus, alkaline phosphatase and total cholesterol using Catalyst One Veterinary Blood Chemistry Analyzer (Manufacturer: IDEXX Laboratories, Inc.).

The data thus obtained were analyzed according to the procedures as described in section 1 of the “General Procedures.”

### Results:

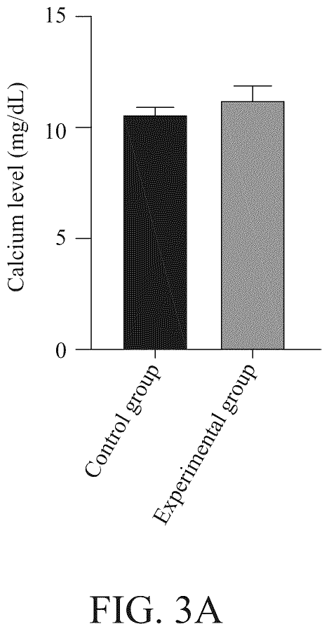

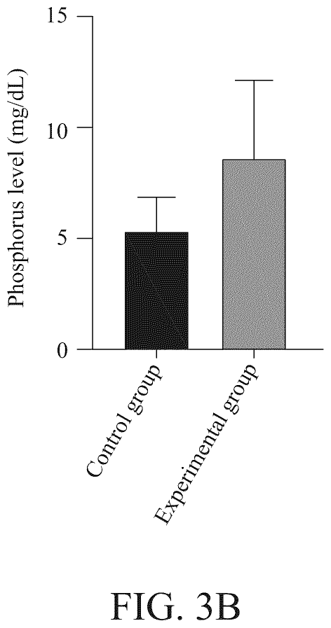

FIGS. 3A and 3B are graphs showing the calcium level and the phosphorus level, respectively, in the serum of the mice of the control group and the experimental group. As shown in FIG. 3A, the calcium level in the serum of the mice of the experimental group was higher than that of the control group, and as shown in FIG. 3B, the phosphorus level in the serum of the mice of the experimental group was higher than that of the control group.

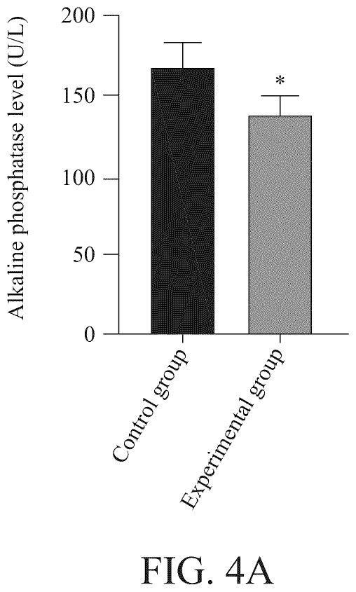

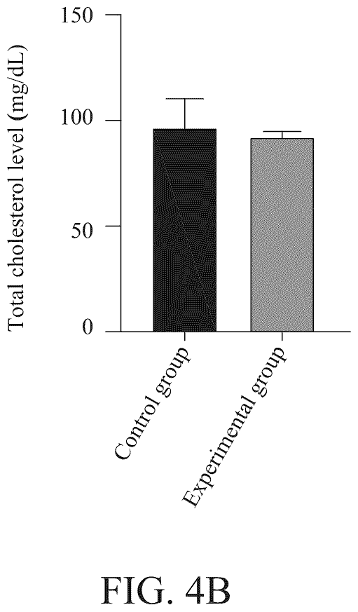

FIGS. 4A and 4B are graphs showing the alkaline phosphatase level and the total cholesterol level, respectively, in the serum of the mice of the control group and the experimental group. It should be noted that, the level of alkaline phosphatase, which is an indicator of bone growth, is generally higher in growing children and pregnant women, while the level of the same in normal adults generally ranges from approximately 20 IU/L to 140 IU/L. A level of alkaline phosphatase that is too high may indicate the presence of diseases, such as bone cancer, multiple myeloma, etc. or medical conditions such as bone fractures, etc. As shown in FIG. 4A, the level of alkaline phosphatase in the experimental group was significantly lower than that of the control group, and was more in line with the normal standard compared to that of the control group, indicating that consumption of the fish bone food product containing the fish bone powder of the present disclosure would not cause abnormality in the level of alkaline phosphatase in the blood. In addition, it should be noted that vitamin D3 has been converted into calcitriol in the fish bone food product containing the fish bone powder of the present disclosure, and in order to ensure that consumption of the fish bone food product containing the fish bone powder of the present disclosure would not cause excessive accumulation of cholesterol in the blood, the mice of the control group and the experimental group were subjected to determination of total cholesterol level. As shown in FIG. 4B, the total cholesterol levels in the serum of the mice of the control group and the experimental group were less than the normal standard level of 200 mg/dL, and the level of total cholesterol of the experimental group was less than that of the control group, indicating that consumption of the fish bone food product containing the fish bone powder of the present disclosure would not have an adverse effect with respect to total cholesterol level in the blood.

### Example 2. Evaluation of the Effect of Fish Bone Powder of the Present Disclosure on Body Weight, Food Intake and the Absorption of Calcium, Phosphorus and Other Biochemical Markers in Ovariectomized Mice

In order to evaluate the efficacy of the fish bone powder of the present disclosure on the absorption of calcium, phosphorus and other biochemical markers, e.g., alkaline phosphatase, total cholesterol, osteocalcin, triglycerides, etc. in ovariectomized mice and to compare the efficacy between the fish bone powder and other types of calcium-supplemented food, the following experiments were conducted.

### A. Effect of Fish Bone Powder in Ovariectomized Mice Over 12 Weeks

The ovaries of the female mice as described in section 1 of the “General Experimental Materials” were removed by ovariectomy when the mice reached the age of 8 weeks old, and then the resultant ovariectomized mice were randomly divided into 6 groups, i.e., pathological control groups 1 and 2, an experimental group, and comparative groups 1 to 3 (n=8 mice in each group). Before feeding the mice in each group with the respective diet as shown in Table 1 below, determination of weight gain and food intake were performed, and blood was collected one time from the vein in the cheek pouch of each mouse as a baseline. Each mouse was fed, via oral gavage, 1 time daily for a total period of 12 weeks.

TABLE 1

| Group | Diet | Source/Manufacturer |
|---|---|---|
| Pathological | Normal chow | Altromin Spezialfutter |
| control group 1 | | GmbH & Co. KG |
| Pathological | Chow devoid of calcium | Dyets, Inc. |
| control group 2 | | |
| Experimental | Fish bone food product | Bone of grouper fish |
| group | including 0.25 wt % of | purchased from Xingde |
| | fish bone powder of | International Co., Ltd. |
| | the present disclosure | |
| Comparative | Normal chow supplemented | Seaweed calcium |
| group 1 | with 0.25 wt % of seaweed | purchased from Hung-Han |
| | calcium | Medical Health Co., Ltd. |
| Comparative | Normal chow supplemented | Calcium carbonate |
| group 2 | with 0.25 wt % of calcium | purchased from Pfizer |
| | carbonate | Biotech Co., Ltd. |
| Comparative | Normal chow supplemented | Calcim citrate purchased |
| group 3 | with 0.25 wt % of calcium | from I-Mei Biomedicine |
| | citrate | Co., Ltd. |

After completing 12 weeks of administration of the respective diet, the mice in each group were subjected to determination of percentage of weight gain so as to exclude the difference caused by administration of the normal chow with administration of the normal chow supplemented with different types of calcium. Since changes in body weight are related to calcium absorption and food intake, the difference in the amount of food intake between the groups was also determined. Thereafter, blood samples were collected from the veins of the cheek pouches of the mice in each group via puncture. Afterwards, the blood samples were subjected to a centrifugation treatment at a speed of 3000 rpm and 4° C. for 10 minutes, so as to collect the resultant supernatants. Subsequently, each of the collected supernatants was diluted with double distilled water, so as to obtain a serum sample. Thereafter, the concentrations of calcium, phosphorus, alkaline phosphatase, and total cholesterol in the serum sample were determined using Catalyst One Veterinary Blood Chemistry Analyzer (Manufacturer: IDEXX Laboratories, Inc.), whereas the concentrations of osteocalcin and triglyceride in the serum sample were determined using an enzyme-linked immunosorbent assay (ELISA) kit.

The data thus obtained were analyzed according to the procedures as described in section 1 of the “General Procedures.”

### B. Effect of Fish Bone Powder in Ovariectomized Mice Over 16 Weeks

The administration of the mice with the respective diet as described in section A of this example was extended until the end of the 16th week. Thereafter, the mice in each group, with exception of the mice of the pathological control group 1, were subjected to determination of the concentrations of calcium, phosphorus, osteocalcin, alkaline phosphatase, total cholesterol, and triglyceride in the serum samples as described in section A of this example.

The data thus obtained were analyzed according to the procedures as described in section 1 of the “General Procedures.”

### Results:

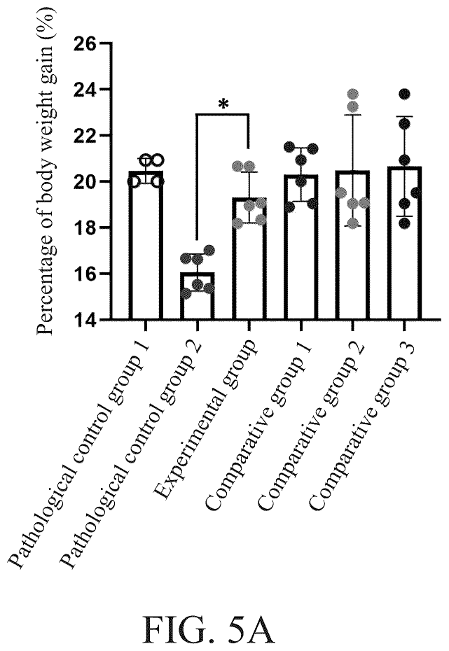

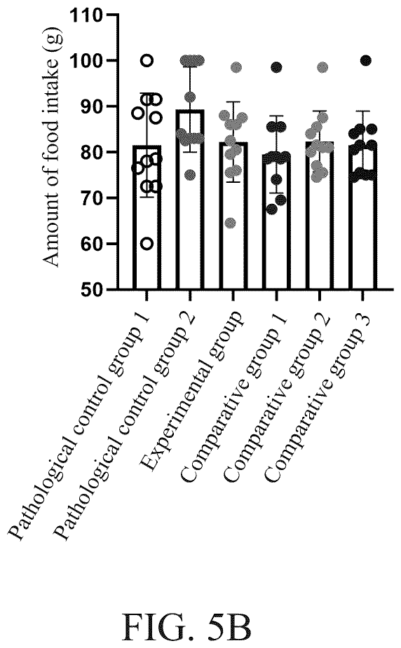

FIG. 5A is a graph showing the percentage of body weight gain for the mice in each group. As shown in FIG. 5A, after 12 weeks of administering the respective diet, the percentages of body weight gain of the mice in the pathological control group 1, experimental group and comparative groups 1 to 3 were quite similar, and were higher compared with the percentage of body weight gain of the mice of the pathological control group 2. FIG. 5B is a graph showing the amount of food intake for the mice in each group. As shown in FIG. 5B, after 12 weeks of administering the respective diet, there was no significant difference in the amount of food intake between the groups, and thus the changes in calcium absorption for the mice in each group were not caused by the different diets respectively administered to the different groups.

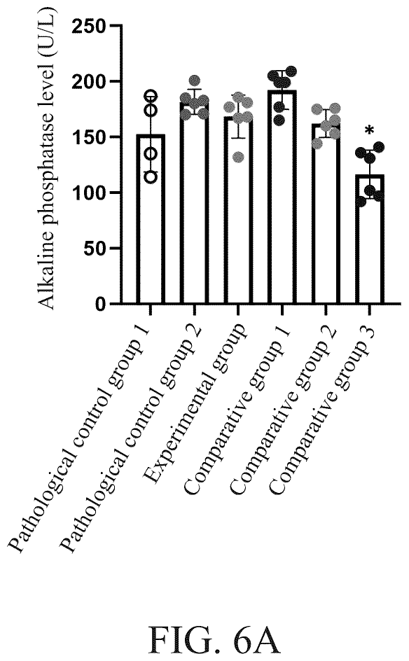

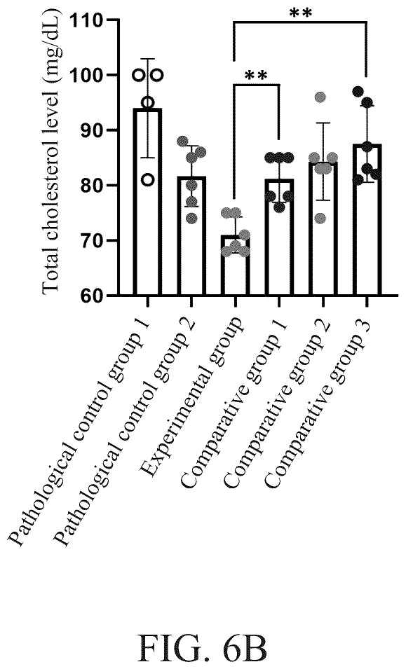

Since alkaline phosphatase plays a key function in the calcification of bones, and calcium absorption is related to total cholesterol level in the blood, measurement of the levels of alkaline phosphatase and total cholesterol was conducted. FIGS. 6A and 6B are graphs showing the alkaline phosphatase level and the total cholesterol level, respectively, in the serum of the mice in each group. As shown in FIG. 6A, after 12 weeks of administering the respective diet, with the exception of the alkaline phosphatase level of the comparative group 3 which was lower than those of the other groups, when the pathological control group 2 was taken as a benchmark for the increased level of alkaline phosphatase relative to the pathological control group 1, the alkaline phosphatase levels of the experimental group, the comparative group 1 and the comparative group 2 were close to each other. As shown in FIG. 6B, after 12 weeks of administering the respective diet, the total cholesterol level of the experimental group was lower than those of the other groups, and was significantly lower compared with those of the comparative groups 1 and 3. These data indicate that consumption of the fish bone food product containing the fish bone powder of the present disclosure would not have adverse effects with respect to the levels of alkaline phosphatase and total cholesterol in the blood.

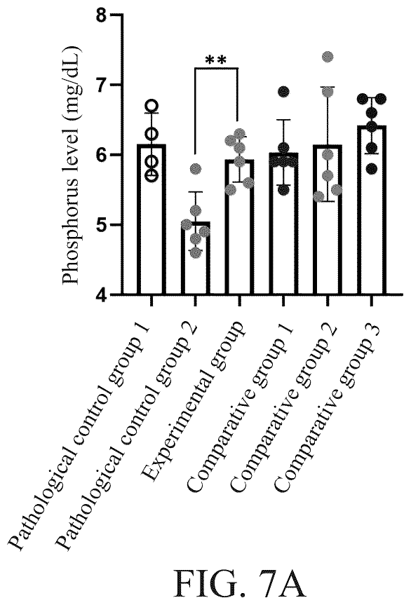

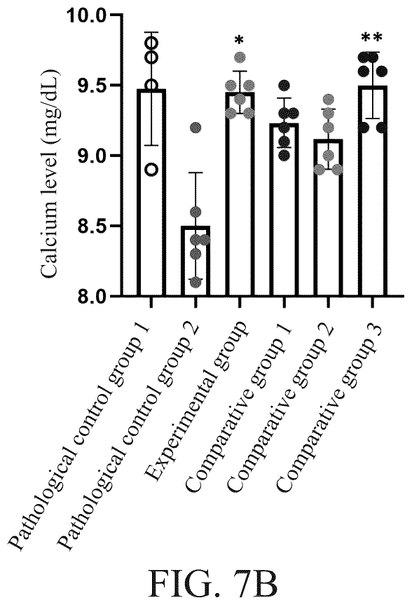

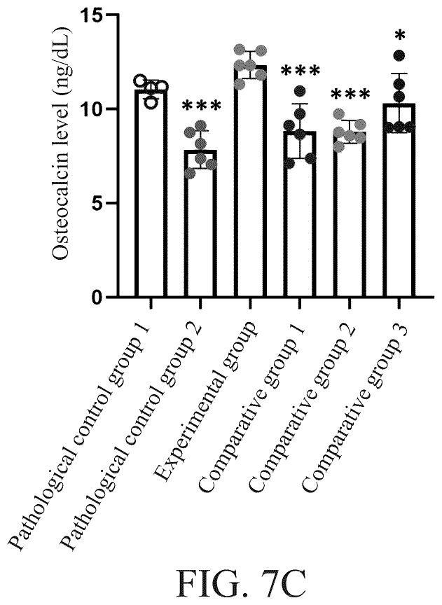

FIGS. 7A to 7C are graphs showing the phosphorus level, calcium level and osteocalcin level, respectively, in the serum of the mice in each group. As shown in FIGS. 7A and 7B, after 12 weeks of administering the respective diet, the phosphorus level and the calcium level of the pathological control group 2 were lower than those of the other groups, whereas the levels of the phosphorus and calcium of the experimental group were significantly higher than those of the pathological control group 2. It should be noted that, apart from collagen, osteocalcin produced by osteoblasts, is the second most abundant bone protein in the bone matrix, and is often used as a marker for bone formation process. Therefore, actual occurrence of bone growth can be determined by measuring the level of osteocalcin in the blood. As shown in FIG. 7C, after 12 weeks of administering the respective diet, the osteocalcin level in the serum of the experimental group was not only higher than that of the pathological control group 2 as expected, but also was higher than those of the comparative groups 1 to 3, indicating that the fish bone food product containing the fish bone powder of the present disclosure has better efficacy than other types of calcium in promoting bone growth.

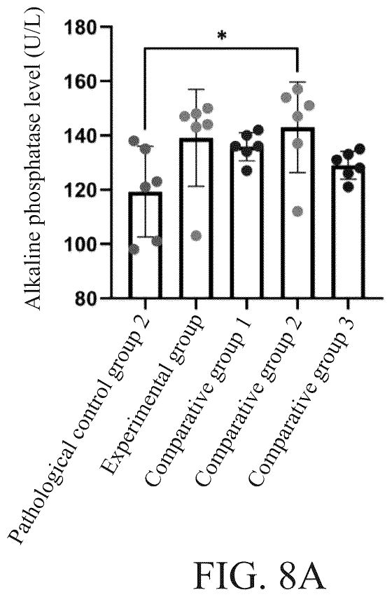

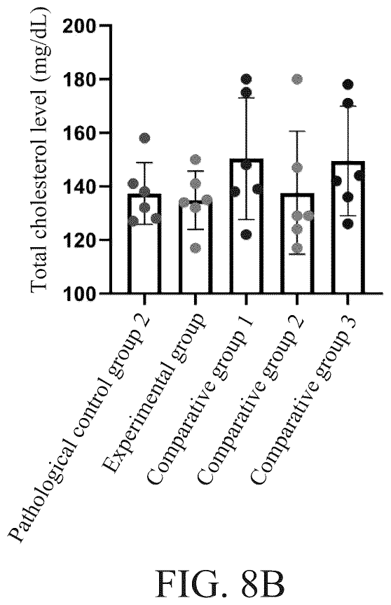

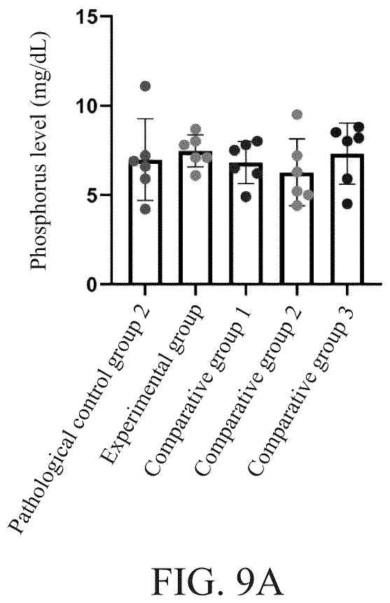

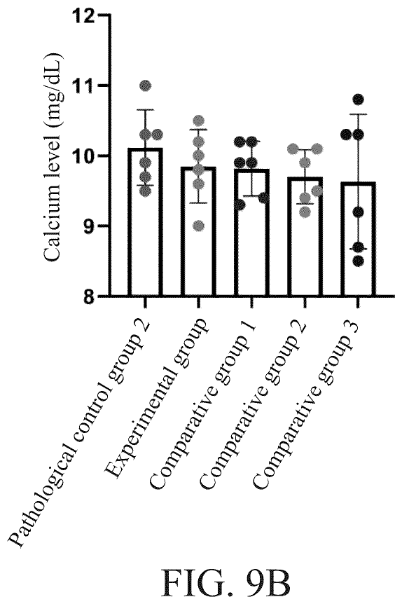

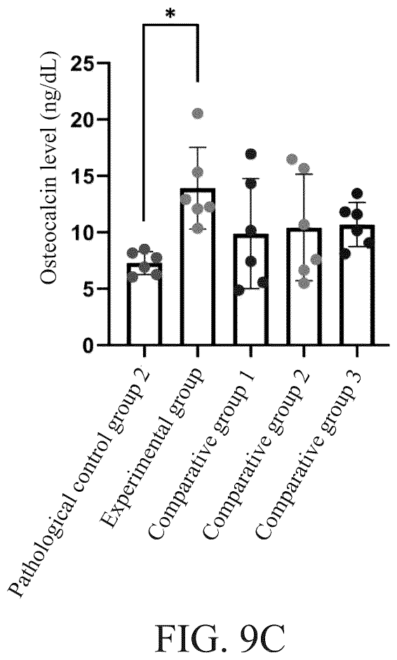

FIGS. 8A and 8B are graphs showing the alkaline phosphatase level and the total cholesterol level, respectively, in the serum of the mice in each group after 16 weeks of administering the respective diet. As shown in FIG. 8A, with reference to FIG. 6A, the alkaline phosphatase level of the experimental group remained largely unchanged at the end of the 16th week compared with that at the end of the 12th week. As shown in FIG. 8B, with reference to FIG. 6B, the total cholesterol level of the experimental group remained lower than those of the other groups, despite demonstrating an increase at the end of the 16th week compared with that determined at the end of the 12th week. FIGS. 9A to 9C are graphs showing the phosphorus level, calcium level and osteocalcin level, respectively, in the serum of the mice in each group after 16 weeks of administering the respective diet. As shown in FIGS. 9A and 9B, with reference to FIGS. 7A and 7B, respectively, the phosphorus level and the calcium level of the experimental group remained largely unchanged at the end of the 16th week compared with those at the end of the 12th week, and were slightly higher than those of the comparative groups 1 to 3. As shown in FIG. 9C, with reference to FIG. 7C, the osteocalcin level of the experimental group remained largely unchanged at the end of the 16th week compared with those at the end of the 12th week, and was clearly higher than those of the comparative groups 1 to 3. These results demonstrate that, in comparison to seaweed calcium, calcium carbonate and calcium citrate, the fish bone powder of the present disclosure still exhibits desirable outcome with respect to the various biochemical markers in the serum when the experiment was extended to last for 16 weeks.

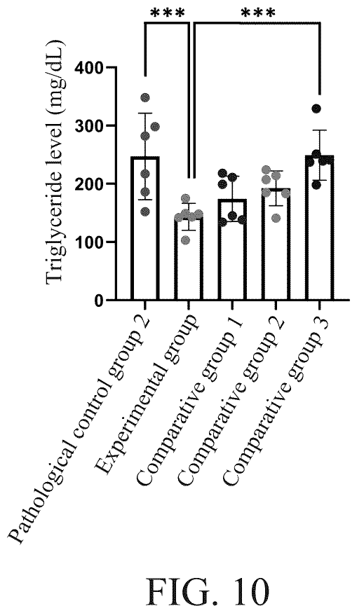

FIG. 10 is a graph showing the triglyceride level in the serum of the mice of each group after 16 weeks of administering the respective diet. As shown in FIG. 10, the triglyceride level of the experimental group was significantly lower than those of the pathological control group 2 and the comparative groups 1 to 3, indicating that the fish bone powder of the present disclosure has better efficacy than other types of calcium in lowering the level of triglyceride in the blood.

In summary, by virtue of the method and the device for preparing the fish bone powder of the present disclosure, the thus obtained fish bone powder of the present disclosure, which contains calcium, phosphorus, collagen, vitamin D3, calcitriol and other nutrients, is capable of facilitating calcium absorption in the body. To be specific, in the method for preparing the fish bone powder of the present disclosure, heating of the powder mixture obtained by mixing the base powder and the medium powder containing calcium and phosphorus allows vitamin D3 to undergo hydroxylation reaction to be converted to calcitriol, which is a biologically active substance that facilitate calcium absorption, and adding the vinegar solution to the processed powder allows vitamin D3 and other nutrients that facilitate calcium absorption, through the fermentation reaction, to be refined and broken down to form small molecules that are relatively easy to be absorbed by the body, so that phosphorus content can also be increased, thereby facilitating calcium absorption from the blood into the bones after achieving a ratio of calcium to phosphorus of 2:1 in the blood, following consumption of the fish bone powder of the present disclosure. In addition, the aforesaid experiments demonstrated that the level of osteocalcin in the blood increased after consumption of the fish bone powder of the present disclosure, indicating that the fish bone powder of the present disclosure indeed is capable of optimizing bone growth and strengthening bones.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for preparing a fish bone powder, comprising the steps of:
(A) providing a medium powder that is made from fish bones and containing calcium and phosphorus, and a base powder containing vitamin D3;
(B) mixing the medium powder and the base powder to obtain a powder mixture;
(C) subjecting the powder mixture to a first heating process conducted at a first temperature ranging from 40° C. to 60° C. and then to a second heating process conducted at a second temperature ranging from 60° C. to 80° C., so as to obtain a processed powder; and
(D) adding a vinegar solution to the processed powder so that the processed powder undergoes a fermentation reaction.

2. The method as claimed in claim 1, further comprising, before step (A), a step (A′) of heating the fish bones by a steaming treatment so as to obtain the medium powder that is water-soluble.

3. The method as claimed in claim 1, wherein in step (A), a fish scale powder containing gelatinous substance is further provided, and in step (B), the medium powder and the base powder are further mixed with the fish scale powder.

4. The method as claimed in claim 3, wherein the medium powder is a fish bone meal including water that is present in an amount of less than 3 wt % based on 100 wt % of the medium powder.

5. A device for preparing a fish bone powder, comprising:
a supply unit including a first feeding module used for storing and feeding a medium powder containing calcium and phosphorus, and a second feeding module that is independent from the first feeding module and that is used for storing and feeding a base powder containing vitamin B3;
a processing unit disposed downstream of the supply unit, the processing unit including a heating furnace that is connected to the first feeding module and the second feeding module, and a stirring mechanism disposed in the heating furnace; and
a supplementing unit connected to the processing unit, and including a supplementary module that is connected to the heating furnace and that is used for feeding a vinegar solution.

6. The device as claimed in claim 5, further comprising a pressure pot that is disposed upstream of the supply unit, and that is used for heating fish bones by a steaming treatment, so as to obtain the medium powder.

7. The device as claimed in claim 5, wherein the supply unit further includes a third feeding module that is connected to the heating furnace and that is used for storing and feeding a fish scale powder containing gelatinous substance.

8. The device as claimed in claim 5, wherein the heating furnace of the processing unit is configured to operate in a plurality of heating modes with different ranges of temperature.

9. A fish bone powder, which is prepared by a method as claimed in claim 1, the fish bone powder containing calcium, phosphorus, collagen, vitamin D3, and calcitriol.
